(19) United States
(12) Patent Application Publication
(10) Pub. No.: US 2011/0099759 A1
(43) Pub. Date: May 5, 2011

(54) HINGE

(75) Inventor: JUNG-BIN CHANG, Tu-Cheng (TW)

(73) Assignee: HON HAI PRECISION INDUSTRY CO., LTD., Tu-Cheng (TW)

(21) Appl. No.: 12/633,664

(22) Filed: Dec. 8, 2009

(30) Foreign Application Priority Data
Oct. 30, 2009 (CN) 200920313748.1

(51) Int. Cl. F16C 11/04; E05D 3/02; E05D 11/10; F16C 11/10

(52) U.S. Cl. 16/331

(57) ABSTRACT

A hinge includes a shaft, a rotation bracket rotatably mounted to the shaft, an interference assembly mounted to the shaft, a biasing member mounted to the shaft, and a fastener fixed to a distal end of the shaft, to prevent the interference assembly and the biasing member from disengaging from the shaft. The interference assembly includes a first element and a second element. The first element includes a first end face located on a first cone tiling down from a circumference towards a center of the first element, and the second element includes a second end face located on a second cone angling down from a center towards a circumference of the second element, to engage the first end surface of the first element.

### CROSS-REFERENCE TO RELATED APPLICATION

This relevant subject matter is disclosed in a co-pending U.S. patent application (Attorney Docket No. US29669) filed on the same date and entitled “HINGE”, which is assigned to the same assignee as this patent application.

### BACKGROUND

1. Technical Field

The present disclosure relates to a hinge.

2. Description of Related Art

A collapsible device, such as a notebook computer, or a clamshell mobile phone, generally includes a base, and a cover pivotally hinged on the base and covering a surface of the base. The hinge generally includes a male interference element and a female interference element for positioning the cover during rotation. The male interference element includes two raised portions and the female interference element includes two depressed portions for receiving the raised portions. When the male interference element is rotated relative to the female interference element, the raised portions are withdrawn from the corresponding depressed portions, resulting in friction between the first and second elements, resulting ion wear on the male and female interference elements. In this process, the male and female interference elements require constant contact with each other for smooth operation, but after a period of use, they can wear down and lose contact with ach other, causing misoperation of the collapsible device.

### BRIEF DESCRIPTION OF THE DRAWINGS

FIG. 1 is an exploded, isometric view of an exemplary embodiment of a hinge, the hinge including an interference assembly.

FIG. 2 is similar to FIG. 1, but viewed from another perspective.

FIG. 3 is an exploded, enlarged view of the interference assembly of FIG. 1, the interference assembly including a first element and a second element.

FIG. 4 is an assembled, isometric view of the hinge of FIG. 1.

FIG. 5 is a sectional view of an assembled view of the first element and the second element of the interference assembly of FIG. 3, showing the interference assembly in a locked state.

FIG. 6 is a similar to FIG. 5, but showing the interface assembly in an unlocked state.

### DETAILED DESCRIPTION

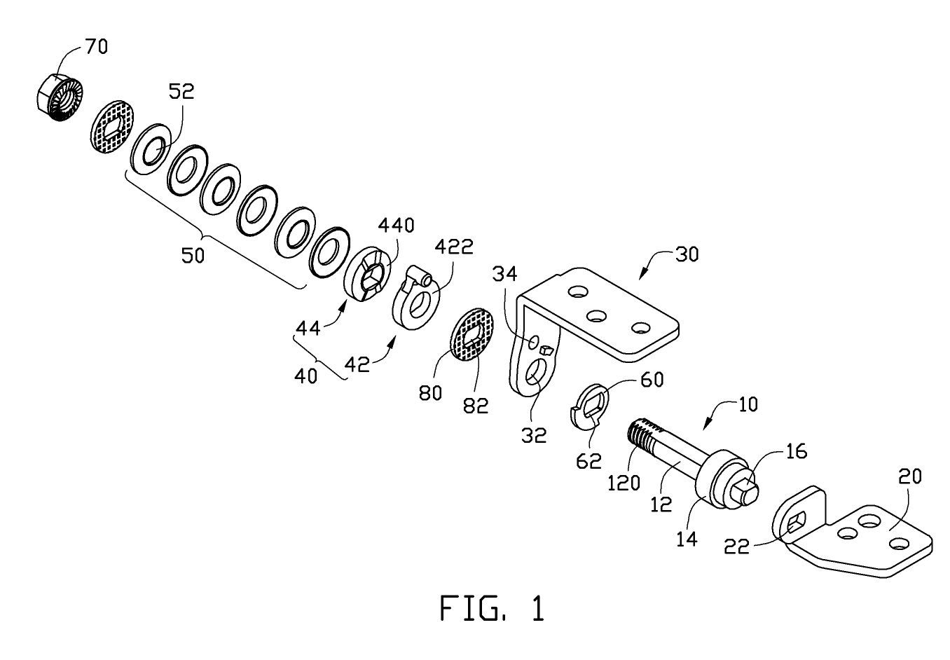

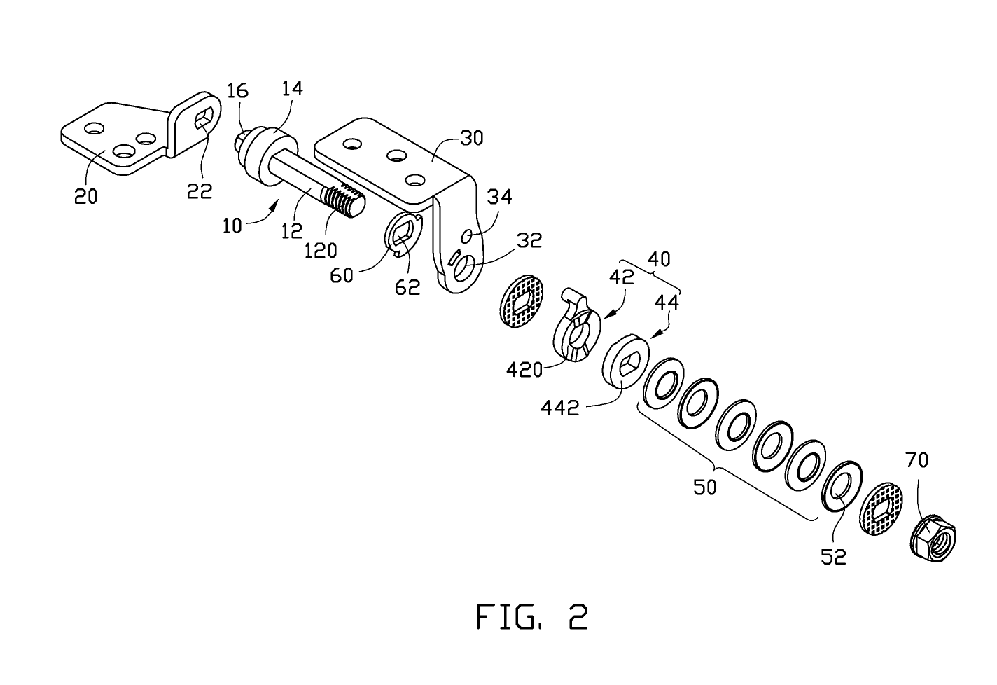

Referring to FIGS. 1 and 2, an exemplary embodiment of a hinge includes a shaft 10, a fixing bracket 20, a rotation bracket 30, an interference assembly 40, a biasing member 50, a block 60, a fastener 70, and two washers 80.

The shaft 10 includes a fixing rod 12 having a generally double-D shaped cross-section. A first end of the fixing rod 12 forms a threaded portion 120, and a second end of the fixing rod 12 opposite to the first end forms a combination block 16. A protrusion 14 protrudes from a circumference of the fixing rod 12, adjacent to the second end of the fixing rod 12.

The fixing bracket 20 defines a double-D shaped fixing hole 22, receiving the combination block 16 of the shaft 10.

The rotation bracket 30 defines a round through hole 32 through which the shaft 10 extends, and a fixing hole 34 neighboring the through hole 32 therein.

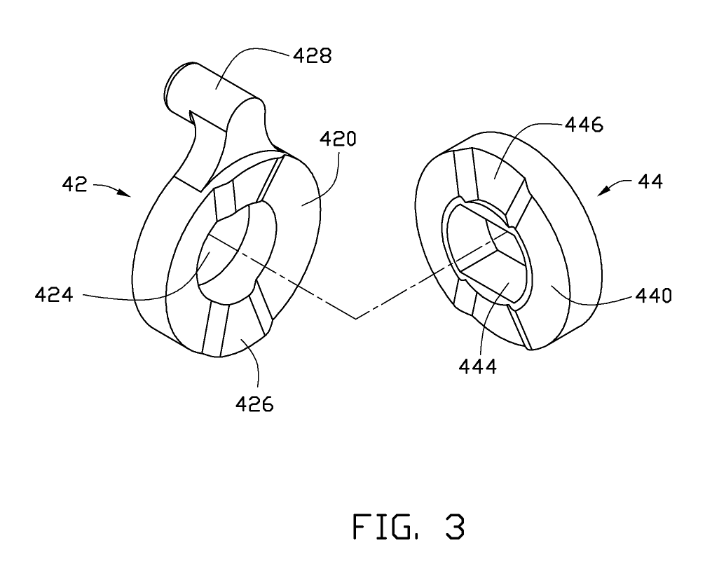

Referring to FIG. 3, the interference assembly 40 includes a first element 42, and a second element 44 engaging and rotating relative to the first element 42.

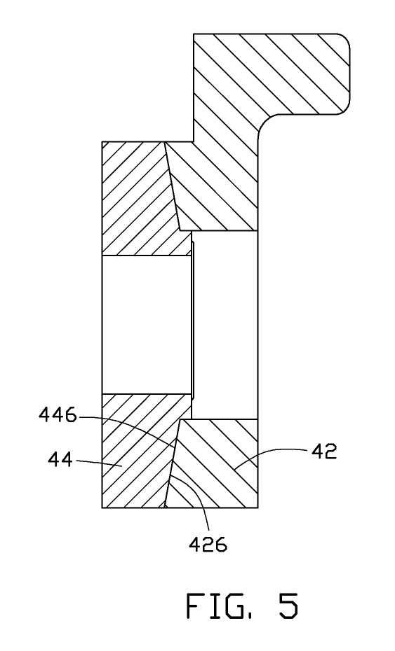

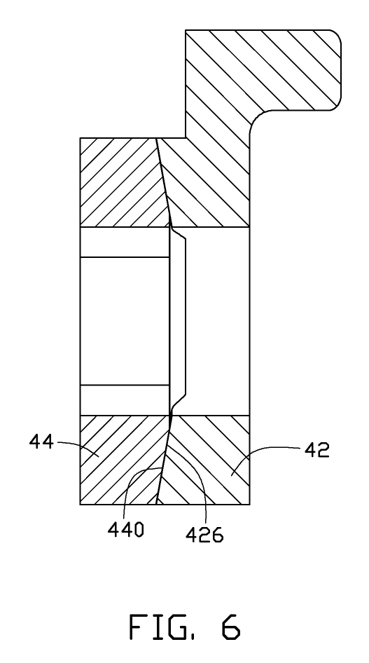

The first element 42 is generally cylindrical and includes a first end surface 420 and a second surface 422 opposite to the first end surface 420. A round through hole 424 is defined in a center of the first element 42, through the first end surface 420 and the second end surface 422, through which the fixing rod 12 of the shaft 10 passes. The first end surface 420 is located on a first cone angling down from a circumference towards the center of the first element 42 (see FIG. 6). Two raised portions 426 protrude symmetrically from the first end surface 420. The top of each raised portion 426 is located on a second cone angling down from the circumference towards the center of the first element 42 (see FIG. 5). A fixing column 428 extends from a circumference of the first element 42, away from the first end surface 420, engaging the fixing hole 34 of the rotation bracket 30. In one embodiment, a taper of the first cone is equal to a taper of the second cone.

The second element 44 is generally cylindrical and includes a first end surface 440 and a second surface 442 opposite to the first end surface 440. A double-D shaped through hole 444 is defined in a center of the second element 44, through the first end surface 440 and the second end surface 442, through which the fixing rod 12 of the shaft 10 passes. The first end surface 440 is located on a third cone angling down from the center towards a circumference of the second element 44 (see FIG. 6). Two depressed portions 446 are symmetrically defined in the first end surface 440, corresponding to the two raised portions 426 of the first element 42. A bottom of each depressed portion 446 is located on a fourth cone angling down from the center towards the circumference of the second element 44 (see FIG. 5). In one embodiment, a taper of each of the third cone and the fourth cone is equal to the taper of the first cone.

The biasing member 50 includes a plurality of elastic elements horizontally stacked together, each defining a through hole 52 through which the fixing rod 12 of the shaft 10 passes.

The block 60 defines a double-D shaped through hole 62 in a center of the block 60, through which the fixing rod 12 of the shaft 10 passes.

In one embodiment, the fastener 70 is a screw cap.

Each washer 80 defines a double-D shaped through hole 82 in a center of the washer 80, through which the fixing rod 12 of the shaft 10 passes.

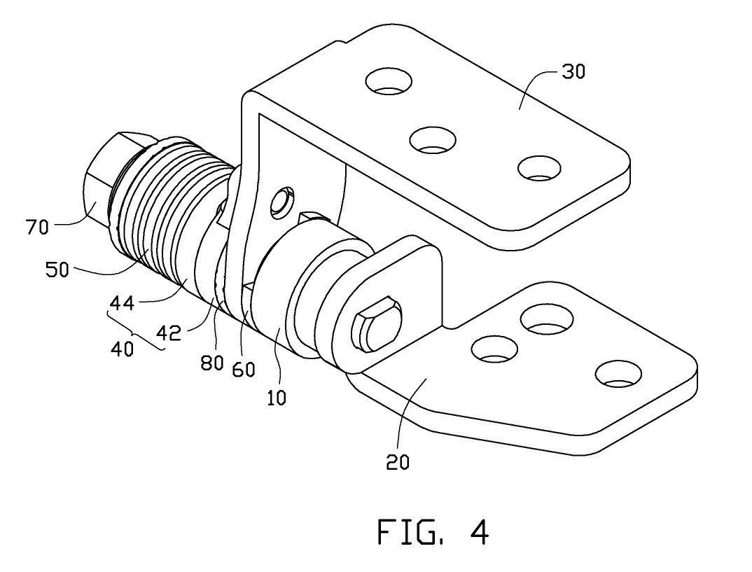

Referring to FIG. 4, during assembly, the combination block 16 of the shaft 10 is received and fixed in the fixing hole 22 of the fixing bracket 20, such that the shaft 10 rotates together with the fixing bracket 20. The fixing rod 12 of the shaft 10 passes though the through hole 62 of the block 60, the through hole 32 of the rotation bracket 30, the through hole 82 of one washer 80, the through hole 424 of the first element 42, the through hole 444 of the second element 44, the through holes 52 of the plurality of elastic elements of the biasing member 50 and the through hole 82 of the other washer 80 in order. The fastener 70 engages the threaded portion 120 of the shaft 10, fixing the fastener 70 to the shaft 10, to prevent the washers 80, the biasing member 50, the interference assembly 40, the rotation bracket 30, and the block 60 from disengaging from the shaft 10. The first element 42 and the second element 44 are in constant contact with each other. The fixing column 428 of the first element 42 engages the fixing hole 34 of the rotation bracket 30. The block 60 resists the protrusion 14 of the shaft 10 and the rotation bracket 30, increasing friction between the protrusion 14 and the rotation bracket 30. The washer 80 located between the first element 42 of the interface assembly 40 and the rotation bracket 30 increases friction therebetween. The first and second elements 42 and 44 face each other, and the depressed portions 446 are capable of engaging with the corresponding raised portions 426.

Referring to FIG. 5, in use, the fixing bracket 20 is fixed to a first part of a collapsible device, such as a notebook computer, and the rotation bracket 30 is fixed to a second part of the collapsible device. When the first part is rotated relative to the second part, the fixing bracket 20 is rotated with the first part, and the shaft 10 rotates together with the fixing bracket 20, such that the second element 44 fixed to the fixing rod 12 of the shaft 10 rotates together with the shaft 10, rotating the second element 44 relative to the first element 42. When the depressed portions 446 of the second element 44 engage the raised portions 426 of the first element 42, the hinge is in a locked state. Because the first end surface 420 and the raised portions 426 of the first element 42 angle down from the circumference towards the center of the first element 42, and the first end surface 440 and the depressed portions 446 of the second element 44 angle down from the center towards the circumference of the second element 44, the first end surface 420 of the first element 42 is in constant contact with the first end surface 440 of the second element 44, applying a radial force on the hinge when the hinge is twisted, avoiding eccentricity and vibration of the hinge.

Referring to FIG. 6, rotating the fixing bracket 20, the raised portions 426 of the first element 42 move out of the depressed portions 446 of the second element 44, such that the raised portions 426 of the first element 42 are rotatable in constant contact with the first end surface 440 of the second element 44, applying a radial force on the hinge when the hinge is twisted, avoiding eccentricity and vibration of the hinge.

The angle of the raised portions 426 of the first element 42 may be adjusted and the angle of the depressed portions 446 of the second element 44 may be also correspondingly adjusted.

In other exemplary embodiments, the first end surface 420 of the first element 24 may define two depressed portions, whereby the first end surface 440 of the second element 44 correspondingly forms two raised portions. The two depressed portions of the first element 42 and the two raised portions of the second element 44 are respectively located on two reciprocating cones.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

1. A hinge comprising:
a shaft;
a rotation bracket rotatably mounted to the shaft;
an interference assembly mounted to the shaft; the interference assembly comprising a first element rotatably mounted to the shaft and fixedly connected to the rotation bracket, and a second element fixed mounted to the shaft and rotatably engaging the first element, the second element rotatable relative to the first element, the shaft passing through the first and the second elements;
a biasing member mounted to the shaft; and
a fastener fixed to the shaft, to prevent the interference assembly and the biasing member from disengaging from the shaft, wherein the first element comprises a first conical end surface, two raised portions are formed at the first conical end surface, each of the raised portions comprises a conical top wall, and the second element comprises a second conical end surface, two depressed portions are formed at the second conical end surface, each of the depressed portions comprises a conical bottom wall, the first conical end surface rotatably contacts with the second conical end surface and the conical top walls rotatably contact with the conical bottom walls.

2. The hinge of claim 1, wherein the center of each of the first element and the second element defines a through hole through which the shaft passes.

3. The hinge of claim 2, wherein the two raised portions are symmetrically located across the through hole of the first element, the two depressed portions are symmetrically located across the through hole of the second element.

4. The hinge of claim 3, wherein the conical top wall of each raised portion is located on a third cone angling down from the circumference towards the center of the first element, and the conical bottom wall of each depressed portion is located on a fourth cone angling down from the center towards the circumference of the second element.

5. The hinge of claim 4, wherein a taper of the third cone is equal to a taper of the fourth cone.

6. The hinge of claim 5, wherein the first conical end surface is located on a first cone angling down from a circumference towards a center of the first element, the second conical end surface is located on a second cone angling down from a center to a circumference of the second element, a taper of the first cone is equal to a taper of the second cone.

7. The hinge of claim 1, wherein the biasing member comprises a plurality of elastic elements horizontally stacked together, and each of the plurality of elastic elements defines a through hole through which the shaft passes.

8. The hinge of claim 1, wherein the rotation bracket defines a fixing hole, and a fixing column extends from a circumference of the first element away from the first conical end surface, engaging in the fixing hole of the rotation bracket.

9. The hinge of claim 6, wherein the taper of each of the first and second cones is equal to the taper of each of the third and fourth cones.
